(19) United States
(12) Patent Application Publication
(10) Pub. No.: US 2024/0253406 A1
(43) Pub. Date: Aug. 1, 2024

(54) WINCH RIGGING LINK

(71) Applicant: MercuryPM Pty Ltd, Kilsyth (AU)

(72) Inventor: Stephen Handbury, Kilsyth (AU)

(21) Appl. No.: 18/632,877

(22) Filed: Apr. 11, 2024

Related U.S. Application Data
(63) Continuation of application No. 18/005,805, filed on Jan. 17, 2023, now Pat. No. 11,981,170.

(30) Foreign Application Priority Data
Oct. 8, 2020 (AU) 2020903642

(51) Int. Cl. B60D 1/02; B60D 1/18; B60D 1/38; B63B 21/10; F16G 11/04; F16G 11/12; F16G 11/14; F16G 15/06

(52) U.S. Cl. CPC B60D 1/02; B60D 1/185; B60D 1/187; F16G 11/14; F16G 15/06; B60D 1/38; B63B 21/10; F16G 11/046; F16G 11/12; Y10T 24/3916; Y10T 24/3991; Y10T 29/49948

(57) ABSTRACT

A winch rigging link has a body defining a cable retainer and a soft shackle retainer at opposite ends. The body has a length, a width less than the length, and a depth less than the width. Furthermore, the body defines opposing faces bounded by the length and width and spaced apart by the depth. The soft shackle retainer comprises a channel running widthwise across the soft shackle retainer an in between the faces. The channel defines a bearing surface having curvature in a lengthwise and widthwise plane. The cable retainer may be permanently attached to a winch cable and the soft shackle retainer attached to a soft shackle or the like when required for winch rigging. The configuration of the link maximises the bend radius of the soft shackle or the like retained by the soft shackle retainer, despite the relatively narrow profile of the body thereof.

### FIELD OF THE INVENTION

This invention relates generally to winch rigging link which, more specifically, may be attached to a conventional winch cable at one end and to a soft shackle at an opposite end.

### BACKGROUND OF THE INVENTION

Many off-road vehicles are equipped with electric or hydraulic winches for towing and recovery operations. The winch reels in a winch cable typically of steel or synthetic rope. The cable is commonly terminated in a winch hook which may be attached to recovery straps.

However, conventional vehicle winch hooks can cut and fray recovery straps and may allow strap ends to escape therefrom during momentary slackness. Furthermore, the hook may be insufficient to hold two ends of a conventional recovery strap therein.

As such, alternatives arrangements include winch hooks comprising retainer gates to retain ends of recovery straps therein. Other arrangements include D-ring shackles having a larger opening to accommodate more than one end of a recovery strap.

These arrangements however are not without disadvantages and the present invention seeks to provide an alternative arrangement which will overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE DISCLOSURE

There is provided herein a winch rigging link having a body defining a cable retainer and a soft shackle retainer at opposite ends.

The body has a length, a width less than the length, and a depth less than the width. Furthermore, the body defines opposing faces bounded by the length and width and spaced apart by the depth.

The soft shackle retainer comprises a channel running widthwise across the soft shackle retainer an in between the faces. The channel defines a bearing surface having curvature in a lengthwise and widthwise plane.

In use, the cable retainer may be permanently attached to a steel or synthetic rope winch cable and the soft shackle retainer attached to a soft shackle or the like when required for winch rigging.

The channel running widthwise across the relatively narrow body of the link maximises the longitudinal bend radius of a soft shackle or the like engaged by the soft shackle retainer, thereby increasing the strain taking resilience of the soft shackle whilst also minimising the volume of the link. The channel may further comprise cross-sectional curvature with respect to a lengthwise and depthwise plane, thereby also increasing the transverse bend radius of the soft shackle.

For example, a minimum diameter of the bearing surface curvature in the lengthwise and widthwise plane to the width of the body ratio may be more than 0.5, preferably 0.75 or more. Furthermore, the minimum diameter of the bearing surface curvature may further be maximised despite the relatively narrow depth of the body wherein a minimum diameter of the bearing surface curvature in the lengthwise and widthwise plane to the depth of the body ratio may be more than 1.5.

As such, for example, the link may have a relatively large minimum bend diameter of approximately 60 mm, despite only having a width of approximately 80 mm and a depth of approximately 35 mm.

Furthermore, the link may be stowed with one face flat against a winch fairlead. The body of the link may have sufficient width to lie flat across openings in both Hawse and roller-type fairleads. At least one face may comprise rubberised bumpers to protect the fairlead plate and prevent movement of the link whilst stowed thereagainst. Furthermore, the widthwise running channel lies on a plane parallel with a surface of the winch fairlead which allows for soft shackle access without impingement even whilst stowed against the fairlead plate.

The cable retainer may comprise a pin similarly running widthwise, thereby able to retain a winch cable thimble orthogonally with respect to a soft shackle.

The body may narrow in the middle in the lengthwise and widthwise plane, thereby defining a substantial figure of eight or infinity symbol shape thereby reducing the overall weight of the link and providing ergonomic portions able to be more easily gripped and handled.

Winch rigging for recovery or towing application using the link may comprise pulling the winch cable and link attached thereto out from against the winch fairlead and inserting a looped end of a soft shackle through the channel and through two looped ends of a recovery straps prior strangulation of a knotted end of the soft shackle with the looped end, thereby defining a loop.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows a front perspective view of a winch link in accordance with an embodiment;

FIG. 2 shows a rear perspective disassembled view of the winch link;

FIG. 3 shows a lengthwise and widthwise plane view of the link;

FIG. 4 shows a lengthwise and depthwise cross-sectional plan view of the link;

FIG. 5 shows a lengthwise and widthwise cross-sectional plan view of the link;

FIG. 6 illustrates recovery line rigging using the winch link; and

FIG. 7 illustrates the attachment of a soft shackle to the winch link.

### DESCRIPTION OF EMBODIMENTS

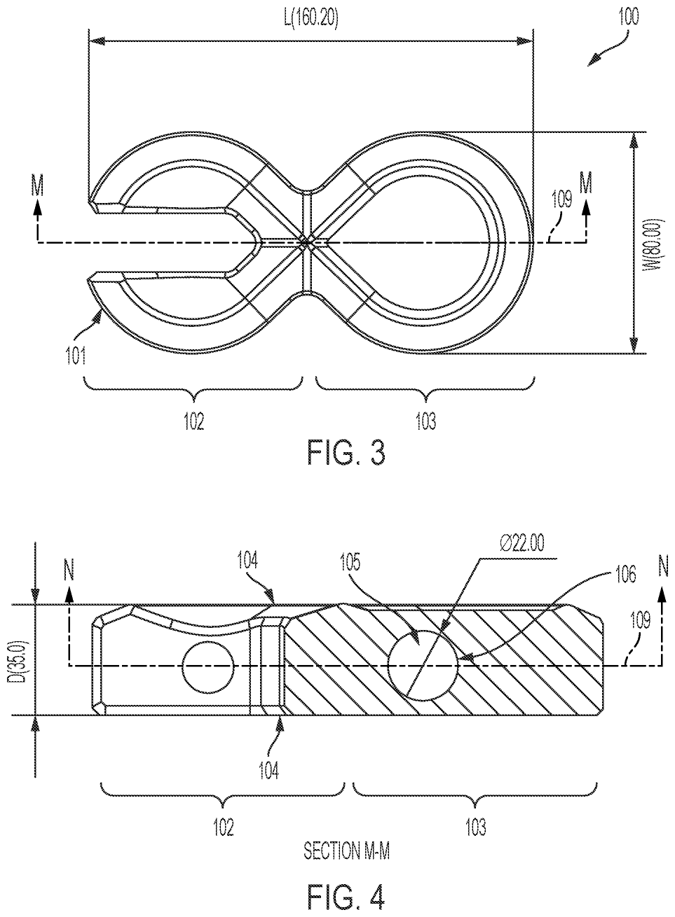

With reference to FIG. 3, a winch rigging link 100 has a body 101 defining a cable retainer 102 and a soft shackle retainer 103 at opposite ends. The body 101 has a length L, a width W less than the length L and, with reference to FIG. 4, a depth D less than the width W.

The length L and the width W define faces 104 spaced apart by the depth of D as indicated generally in FIG. 4.

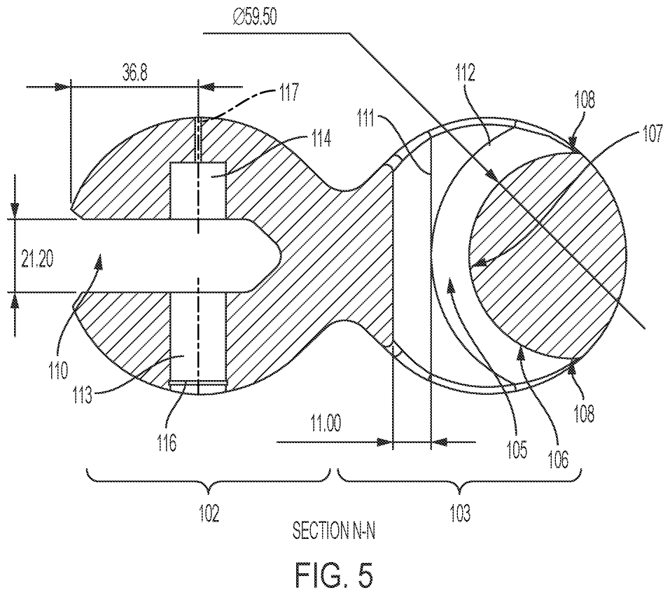

With reference to FIG. 5, the soft shackle retainer 103 comprises a channel 105 running widthwise across the soft shackle retainer 103 between the faces 104.

With reference to FIG. 5, the channel 105 defines a bearing surface 106 having curvature in a lengthwise and widthwise plane (i.e. the plane shown in FIG. 5). The curvature 106 may define an apex 107 towards the cable retainer 102 and ends 108 away from the cable retainer 102.

The ends 108 may be substantially parallel with a lengthwise axis 109 of the body 101.

The enlarged diameter of the bearing surface 106 increases the bend radius of a soft shackle engaged by the soft shackle retainer 103. In this regard, the diameter of the bearing surface 106 may be maximised given the width W of the body 101.

With reference to FIG. 5, a minimum diameter of the bearing surface 106 in the lengthwise and widthwise plane to the width W of the body 101 is preferably more than 0.5, further preferably greater than 0.6 and yet further preferably approximately 0.75 or more. FIG. 5 shows wherein the minimum diameter is approximately 59.5 mm whereas, with reference to FIG. 3, the width W is given as approximately 80 mm. As such, the ratio of the minimum diameter of the bearing surface 106 to the width W of the embodiment shown is approximately 0.75.

The diameter of the bearing surface 106 may further be maximised despite the narrowness (i.e. depth D) of the body 101. In this regard, a minimum diameter of the bearing surface 106 in the lengthwise and widthwise plane to the depth D of the body 101 ratio is preferably more than 1.5. According to the embodiment shown, a minimum diameter of approximately 59.5 mm as shown in FIG. 5 to the depth of approximately 35 mm shown in FIG. 4 gives a ratio of approximately 1.7.

With reference to FIG. 5, the curvature of the bearing surface 106 in the lengthwise and widthwise plane may have constant radius, thereby conferring a uniform bend radius to the soft shackle to enhance the strain taking capacity thereof.

The bearing surface 106 may further have cross-sectional curvature with respect to a lengthwise and depthwise plane (i.e. the plane shown in FIG. 4). The cross-sectional curvature may have a diameter of more than 20 mm, such as approximately 22 mm as shown in FIG. 4.

With reference to FIG. 5, the channel 105 may be shaped to define a straight axis 111 and a tangential curved axis 112. As such, the channel 105 has greater accessibility for inserting a looped end of a soft shackle therethrough.

The diameter of the channel 105 may be substantially less than the diameter of the bearing surface 106, such as less than half the diameter of the bearing surface 106. For example, as is shown in FIG. 4, the width of the channel 105 may be 22 mm whereas, with reference to FIG. 5, the diameter of the bearing surface 106 may be 59 mm. Furthermore, the channel 105 may be substantially long so as to curve (i.e., the length of the central axis 112) through the width W of the link 100 of approximately 80 mm.

Whereas the bearing surface 106 of the soft shackle retainer 103 may have curvature in the lengthwise and widthwise plane, a bearing surface of the cable retainer 102 may have curvature in the lengthwise and depthwise plane (i.e., orthogonally with respect to the bearing surface 106 of the soft shackle retainer 103).

The bearing surface of the cable retainer 102 may be defined by a pin 128.

In this regard, the cable retainer 102 may comprise an opening or channel 110 through the cable retainer 102 running depthwise (i.e., through the bearing faces 104 as compared to between the bearing faces 104).

With reference to 2, the cable retainer 102 may comprise a pin 128 across the opening 110. The pin 128 may run widthwise in between the bearing faces 104.

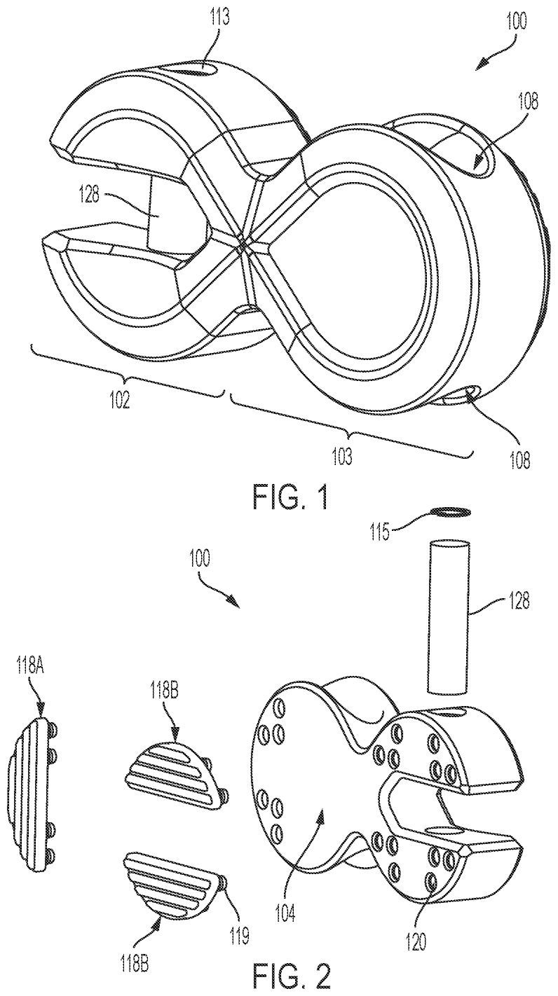

With reference to FIG. 2, the cable retainer 102 may be bifurcated with respect to the longitudinal axis 109 and comprise a through hole 113 in a first portion thereof for the insertion of the pin 128 therethrough and an inner blind hole 114 in a second portion thereof for an end of the pin 128. A circlip 115 may retain the pin 128 against a recessed edge 116 shown in FIG. 5. The blind hole 114 may lead to a relief channel 117.

With reference to FIG. 4, the bearing faces 104 may define parallel planes.

With reference to FIG. 2, the link 100 may comprise bumpers 118 in one or both faces 104. The bumpers 118 may comprise rubber and may be retained to the bearing face 104 with barbed tips 119 and corresponding apertures 120. The bumpers 118 may comprise a widthwise orientated bumper 118A for the soft shackle retainer 103 and a pair of longitudinal orientated bumpers 118B for each portion of the bifurcated cable retainer 102.

With reference to FIG. 5, the body 101 may narrow in the middle in the lengthwise and widthwise plane. As such, the body 101 may define a figure-of-eight or infinity symbol shape in the lengthwise and widthwise plane. Furthermore, each of the cable retainer 102 and the soft shackle retainer 103 may have a circular cross-section and the lengthwise and widthwise plane.

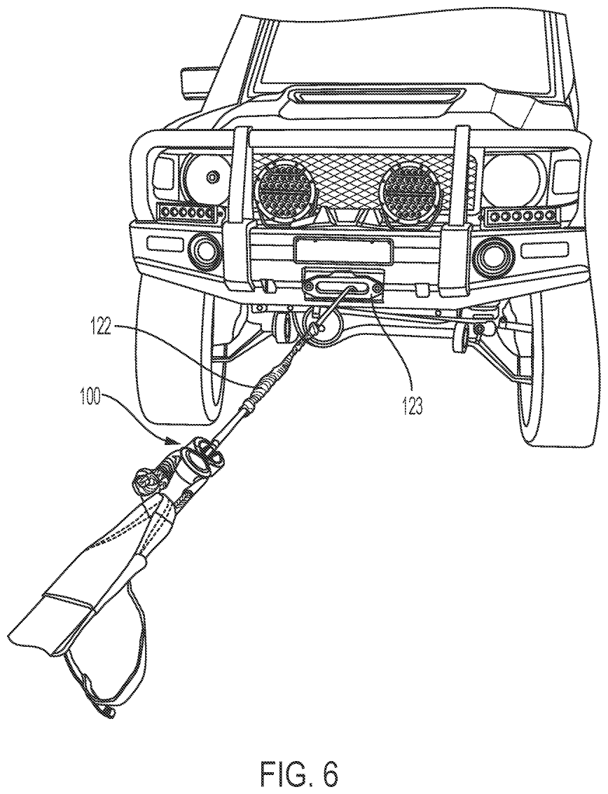

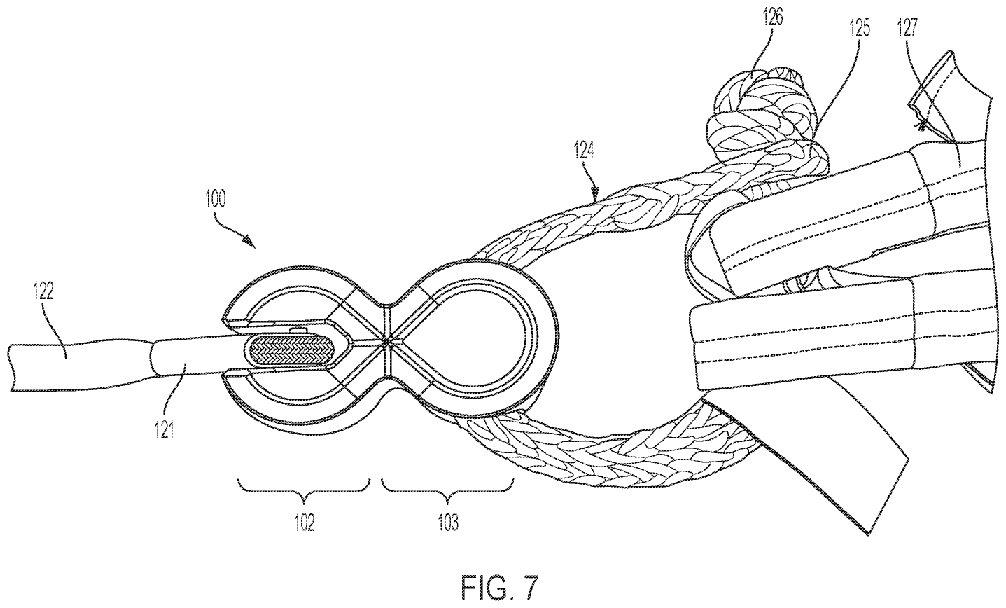

FIGS. 6 and 7 illustrate the utilisation of the link for winch rigging.

With reference to FIG. 7, the link 100 may be permanently attached to a thimble 121 of a winch line 122 by removing the pin 128, inserting the thimble 121 into the opening 110 of the cable retainer 10 to and reinserting the pin 128. As alluded to above, the pin 128 is retained in position by the circlip 115. Furthermore, the pin 128 does not protrude out from beyond the body 101 when retained within the holes 113, 114.

The winch cable 122 may be a steel or synthetic rope winch cable. With reference to FIG. 5, the opening 110 may comprise a width of greater than 20 mm to accommodate most commercially available winch cable thimbles 121 therein.

The link 100 may be stowed by winching the link 100 against the fairlead 123 so that one of the bearing faces 104 lies flat against the fairlead 123. With reference to FIG. 3, the link 100 may have sufficient width to lie across the opening through the fairlead 123. In the embodiment shown in FIG. 6, the fairlead 123 is a Hawse-type fairlead 123 although the link 100 can alternatively lie flat against a roller-type fairlcad. Preferably, only the bearing face 104 comprising the bumpers 118 lies against the fairlead 123.

For towing or recovery use, the winch line 122 may be pulled out from the fairlead 123 and a soft shackle 124 attached to the soft shackle retainer 103. Specifically, a looped end 125 of the soft shackle 124 is able to fit through the channel 105 whereafter the looped end 125 may strangulate a knotted end 126 of the soft shackle 124, thereby completing a loop.

Two looped ends of a retention strap 127 may engage the soft shackle 124.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

The term “approximately” or similar as used herein should be construed as being within 10% of the value stated unless otherwise indicated.

1. A system comprising:
a winch rigging link defining a cable retainer and a soft shackle retainer between opposing faces, the soft shackle retainer defining a curved soft shackle bearing surface curving between the faces away from the cable retainer;
a fairlead; and
a winch line passing through the fairlead, wherein the winch line is engaged by the cable retainer; and
a soft shackle bears against the soft shackle bearing surface.

2. The system as claimed in claim 1, wherein the winch line is engaged between bifurcated portions of the cable retainer.

3. The system as claimed in claim 2, wherein the winch line is engaged by a pin spanning between the bifurcated portions.

4. The system as claimed in claim 2, wherein the cable retainer is bifurcated with respect to a longitudinal axis defined by the winch rigging link.

5. The system as claimed in claim 3, wherein the pin is removable via a hole through one of the bifurcated portions.

6. The system as claimed in claim 5, wherein a distal end of the pin is engaged in an inner blind hole in one of the bifurcated portions.

7. The system as claimed in claim 1, wherein the soft shackle bearing surface bearing surface further has curvature along its length.

8. The system as claimed in claim 1, wherein ends of the soft shackle bearing surface are parallel.

9. The system as claimed in claim 8, wherein ends of the soft shackle bearing surface are parallel with respect to a longitudinal axis defined by the winch rigging link.

10. The system as claimed in claim 1, wherein curvature of the soft shackle bearing surface has a diameter greater than a width of the winch rigging link.

11. The system as claimed in claim 10, wherein curvature of the soft shackle bearing surface has a constant radius.

12. The system as claimed in claim 1, wherein a channel through the soft shackle retainer defining the bearing surface defines a straight axis and a tangential curved axis.

13. The system as claimed in claim 1, wherein the cable retainer defines a cable bearing surface and wherein the cable bearing surface and the soft shackle bearing surface engage the winch line and the soft shackle in orthogonal planes respectively.

14. The system as claimed in claim 13, wherein the cable bearing surface is defined by a pin.

15. The system as claimed in claim 1, wherein one of the faces is pulled flat against the fairlead by the winch line in a stowed configuration.

16. The system as claimed in claim 15, further comprising bumpers interfacing the winch rigging link and the fairlead.

17. The system as claimed in claim 1, wherein a longitudinal axis of the winch rigging link is in alignment with the winch line in a winching configuration.

18. The system as claimed in claim 1, wherein the winch rigging link narrows between the cable retainer and the soft shackle retainer.

19. The system as claimed in claim 18, wherein the winch rigging link defines a figure-of-eight profile.

20. The system as claimed in claim 19, wherein the cable retainer and soft shackle retainer each partially define a respective circular cross-section.
